(19) United States
(12) Patent Application Publication
(10) Pub. No.: US 2001/0039621 A1
(43) Pub. Date: Nov. 8, 2001

(54) IC card and IC card utilization system

(76) Inventors: Takeshi Yamamoto, Hirakata-shi (JP); Joji Katsura, Nishinomiya-shi (JP)

Correspondence Address: PARKHURST & WENDEL, L.L.P., 1421 Prince Street, Suite 210, Alexandria, VA, 22314-2805, US

(21) Appl. No.: 09/814,837

(22) Filed: Mar. 23, 2001

(30) Foreign Application Priority Data
Mar. 23, 2000 (JP) 2000-081126

(51) Int. Cl. H04L 9/32

(52) U.S. Cl. 713/194

(57) ABSTRACT

The present invention provides an IC card and an IC card utilization system, which are excellent in security. An IC card 100 comprises a microcomputer 102 having a program processor 104 for executing a program, a ROM 101 for containing an encrypted program executed by the program processor 104, a key storage unit 105 for containing a secret key, and a cipher decoder 103 for decoding the encrypted program from the ROM 101 using the secret key from the key storage unit 105 and giving the decoded program to the program processor 104.

### FIELD OF THE INVENTION

The present invention relates to an IC card and an IC card utilization system and, more particularly, to an IC card and an IC card utilization system comprising a microcomputer.

### BACKGROUND OF THE INVENTION

At present, magnetic cards are widely used in various cards such as cash cards, credit cards, phone cards and coupon tickets for trains, but problems of tampering or forged cards have also been brought to the fore.

On the other hand, IC cards are developed as cards which are excellent in the aspect of security and tampering resistance, i.e., withstanding unauthorized uses of information, and in Japan, the phone cards have been already put to practical use and used in some regions. Hereafter it is expected that a migration from the present magnetic cards to the IC cards is progressed owing to the cost reduction by minimizing chips or otherwise. Particularly, the IC card containing a microcomputer is expected not only to have a function just as a data storage medium but also to be utilized in a system requiring the high-level security and tampering resistance, such as electronic moneys.

In the prior art IC card, a predetermined security level is ensured, but this is not 100% safe. Therefore, as the importance of data is increased more, it is necessary to add an additional security function to the present IC card.

FIG. 4 is a diagram schematically illustrating an example of the prior art IC card containing a microcomputer. The IC card 400 comprises a microcomputer 402 for executing a program. In a ROM (read only memory) 401, the program executed by the microcomputer 402 is stored. A RAM (random access memory) 407 contains data processed by the microcomputer 402, or data which are input/output to/from an external IC card reader/writer (not shown) via a reader/writer I/F (interface) 409 and a Logic circuit 408 as required. The Logic circuit 408 subjects data or command input from the reader/writer I/F 409 to serial/parallel conversion, checks the same, and when a command is input, gives an instruction to the microcomputer 402 to read the program from the ROM 401. The microcomputer 402, the ROM 401, the RAM 407, and the Logic circuit 402 are connected via a bus 406. In addition, data on the bus 406 are input or output to or from the input/output reader/writer I/F 409 via the Logic circuit 408, and input or output to or from outside through the input/output reader/writer I/F 409.

The prior art IC card 400 containing the microcomputer 402 has the ROM 401 containing the program executed by the microcomputer 402, and there is a possibility that the information of the program can be obtained by measuring the potential of each bit of the ROM 401 by the tampering, for example using a manual prober. Further, there is a possibility that the program in the ROM 401 can be extracted by monitoring the bus 406 connecting the ROM 401 and the microcomputer 402. When the program is illegally extracted in this way, there is a risk that this program is tampered or used for bad purposes such as forged card creation. As described above, in the prior art IC card 400, there are some cases where the security cannot be adequately maintained.

### SUMMARY OF THE INVENTION

It is an object of the present invention to provide an IC card and an IC card utilization system, which are excellent in security.

Other objects and advantages of the present invention will become apparent from the detailed description and specific embodiments described are provided only for illustration since various additions and modifications within the spirit and scope of the invention will be apparent to those of skill in the art from the detailed description.

An IC card according to a 1st aspect comprises: a microcomputer having a program processing means for executing a program; a program storage means for containing the program executed by the program processing means, at least part of the program having been encrypted; a key storage means for containing key information; and a cipher decoding means for decoding the encrypted program from the program storage means using the key information from the key storage means while giving the program directly to the program processing means. Therefore, even when the program which is stored in the program storage means and executed in the IC card is read out illegally using the manual prober or the like, since this program is encrypted, the contents of the program are prevented from being obtained, whereby the IC card having an excellent security function can be provided.

According to a 2nd aspect of the present invention, in the IC card of the 1st aspect, the cipher decoding means is provided in the microcomputer. Therefore, it makes difficult to find the line between the cipher decoding means and the program processing means from outside, whereby the decoded program which is output from the cipher decoding means can be prevented from being illegally extracted and the IC card having a more excellent security function can be provided.

According to a 3rd aspect of the present invention, in the IC card of the 1st aspect, the program stored in the program storage means is encrypted using a public key of a public key cryptosystem, and the key information stored in the key storage means is a secret key of the public key cryptosystem. Therefore, the IC card having an excellent security function can be provided.

According to a 4th aspect of the present invention, in the IC card of the 1st aspect, the program stored in the program storage means is encrypted using a common key of a common key cryptosystem, and the key information stored in the key storage means is the common key of the common key cryptosystem. Therefore, the IC card having a higher processing speed can be provided.

According to a 5th aspect of the present invention, in the IC card of the 1st aspect, the program storage means is one of a ROM, a nonvolatile memory other than a ROM, and a RAM. Therefore, the IC card having an excellent security function can be provided.

An IC card utilization system according to a 6th aspect of the present invention comprises: an IC card reader/writer having a program storage means for containing a program, a first key storage means for containing first key information and encrypting the program in the program storage means using the first key information, and a first interface means for outputting the encrypted program outside; and an IC card having a second interface means for receiving the encrypted program output from the IC card reader/writer; a second key storage means for containing second key information; and a microcomputer comprising a cipher decoding means for decoding the encrypted program input from the IC card reader/writer via the second interface means using the key information from the second storage means, and a program processing means for executing the decoded program. Therefore, even when the program executed in the IC card is read out illegally by the leakage of the data transmitted from the reader/writer to the IC card or the monitoring of the memory or data bus, since this program is encrypted, the program contents are prevented from being obtained, whereby the IC card utilization system having an excellent security function can be provided.

According to a 7th aspect of the present invention, in the IC card utilization system of the 6th aspect, the first key information is a public key of a public key cryptosystem, and the second key information is a secret key of the public key cryptosystem. Therefore, the IC card utilization system having an excellent security function can be provided.

According to an 8th aspect of the present invention, in the IC card utilization system of the 7th aspect, card authentication is performed by decoding with operating the encrypted program, using the secret key stored in the second key storage means. Therefore, the IC card utilization system having an excellent security function can be provided, as well as the IC card utilization system which can perform the judgement of the card authentication more accurately can be provided.

### BRIEF DESCRIPTION OF THE DRAWINGS

FIG. 1 is a block diagram illustrating a structure of an IC card according to a first embodiment of the present invention.

FIG. 2 is a block diagram illustrating a structure of an IC card according to a second embodiment of the present invention.

FIG. 3 is a block diagram illustrating a structure of an IC card utilization system according to a third embodiment of the present invention.

FIG. 4 is a block diagram illustrating a structure of a prior art IC card.

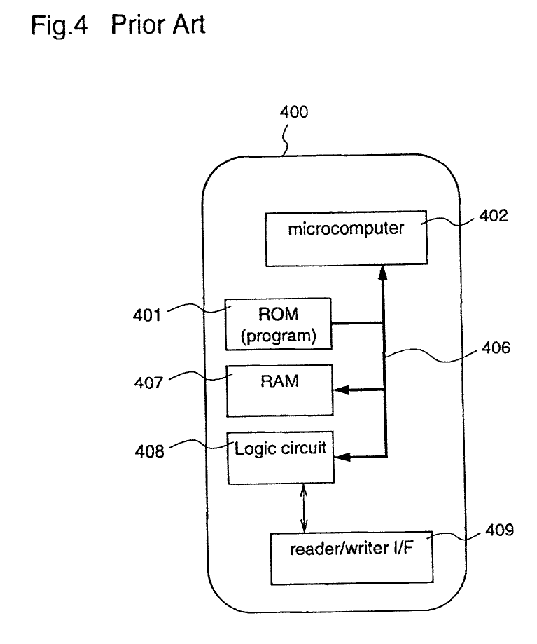

FIG. 5 is a block diagram illustrating a structure of a variation of the IC card according the second embodiment.

### DETAILED DESCRIPTION OF THE PREFERRED EMBODIMENTS

### Embodiment 1

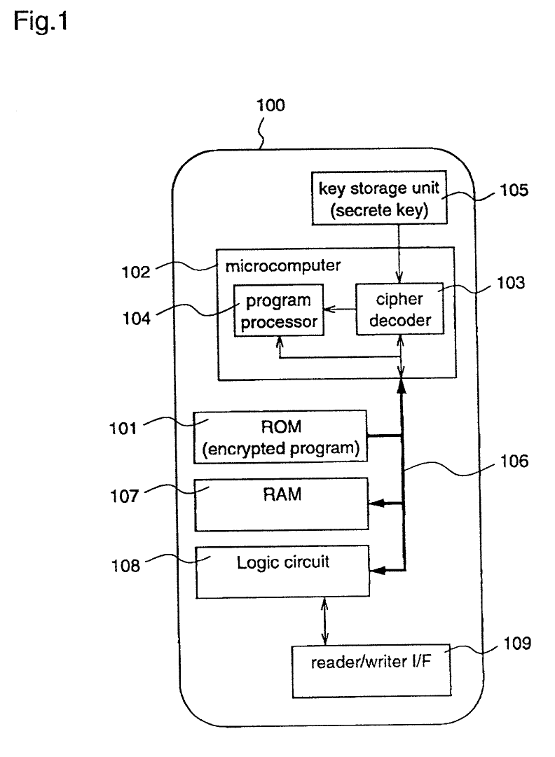

FIG. 1 is a block diagram illustrating a structure of an IC card according to the first embodiment of the present invention. In this figure, the IC card 100 comprises a ROM 101, a microcomputer 102, a RAM 107 and a Logic circuit 108 which are connected each other via a data bus 106, as well as a reader/writer I/F 109 connected with the data bus 106 via the Logic circuit 108, for performing input/output of data to/from outside. A program executed by a program processor 104 is encrypted by a public key of the public key cryptosystem and stored in the ROM 101. The RAM 107 contains data processed by the microcomputer 102 or data which are input or output to or from an external IC card reader/writer (not shown) via the reader/writer I/F 109 and the Logic circuit 108 as required. The Logic circuit 108 performs serial/parallel conversion of data or command which is input or output by the reader/writer I/F 109 or input check of the same or the like, as well as performs input/output of data between the data bus 106 and the reader/writer I/F 109. In addition, when the command is input from outside to the reader/writer I/F 109, the Logic circuit 108 gives an instruction to the microcomputer 102 to read the program from the ROM 101. A key storage unit 105 comprising a memory such as a nonvolatile memory contains key information, and this key information is output to the microcomputer 102 as required. In this first embodiment, a secret key of the public key cryptosystem, corresponding to the above-mentioned public key is stored as the key information. The microcomputer 102 includes a program processor 104 for executing the program, and a cipher decoder 103 for carrying out a cryptanalysis process for the encrypted program read from the ROM 101 (hereinafter referred to as encrypted program), i.e., decoding the encrypted program, using the secret key 105 output from the key storage unit 105. The program processor 104 executes the decoded program output from the cipher decoder 103. Further, programs or data which are not encrypted are input to the program processor 104 not via the cipher decoder 103 and executed.

Hereinafter, the operation of the so-constructed IC card according to the first embodiment will be described. When the data or command is input to the Logic circuit 108 in the IC card 100 via the reader/writer I/F 109, the serial/parallel conversion is performed by the Logic circuit 108. Here, when a command for executing a predetermined program is input, the Logic circuit 108 notifies the microcomputer 102 that the command is input. Then, the microcomputer 102 receives this notification and reads the program specified by the command from the ROM 101. An instruction set of the encrypted program which has been encrypted by the public key of the public key cryptosystem, read from the ROM 101 is transmitted to the cipher decoder 103 in the microcomputer 102 via the data bus 106 in an encrypted state. The cipher decoder 103 decodes the instruction set of the encrypted program into an instruction set of a normal program using the secret key 105 of the public key cryptosystem stored in the key storage unit 105. The decoded instruction set of the program is directly transmitted to the program processor 104 in the microcomputer 102 without being temporarily stored in a writable memory such as a RAM or passing the bus. In this way, the program processor successively and directly processes the instruction set of the program, which have been successively decoded by the cipher decoder, thereby executing the program.

In the IC card according to the first embodiment, the program used in the program processor 104 is encrypted and stored in the ROM 101. Therefore, even when the program is directly extracted from the ROM using the manual prober or the like, since this program is encrypted, the meaningful data cannot be extracted. That is, the contents of the encrypted program cannot be easily decoded. Further, even when the IC card 100 is operated similarly to read the program from the ROM 101 via the data bus 106, the extracted program is encrypted, thereby the same result is obtained, i.e., the meaningful data cannot be extracted. Therefore, the IC card which is excellent in the security function can be provided.

Further, since the cipher decoder 103 is provided in the microcomputer 102, a line connecting the cipher decoder 103 and the program processor 104 is hidden in high-density lines in the microcomputer 102. Therefore, it can be made difficult to find this line, and the decoded program output from the cipher decoder 103 can be prevented from being extracted using the manual prober or the like.

In this first embodiment, the cipher decoder 103 for decoding the encrypted program is provided inside the microcomputer 102. However, this may be provided outside the microcomputer 102. Also in this case, it is necessary to carry out the delivery of the program from the decoder unit 103 to the program processor 104 not via the data bus 106 but by using a special signal line, thereby preventing the decoded program from being read from the data bus 106.

It is not always necessary to decode all programs in the ROM 101 and it is also possible to decode part of the programs, for example only important programs.

In this first embodiment, the public key cryptosystem is used as the cryptosystem of the program while it is also possible to use the common key cryptosystem or other cryptosystem and store key information which can decode a cipher thereof in the key storage unit 105. Also in this case, the same effects as in the first embodiment can be obtained. Generally in the common key cryptosystem, the processing time required for the decoding is shorter. On the other hand, the public key cryptosystem has a higher security function. Thus, it is preferable to use the common key cryptosystem in a case where the priority is given to the processing speed and use the public key cryptosystem in a case where the priority is given to the security.

Further, in this first embodiment, the case where the encrypted program is stored in the ROM 101 is described. However, in this invention, a nonvolatile memory or a RAM other than the ROM can be used as the program storage means for containing the encrypted program. Also in this case, the same effects as those in the first embodiment can be obtained.

### Embodiment 2

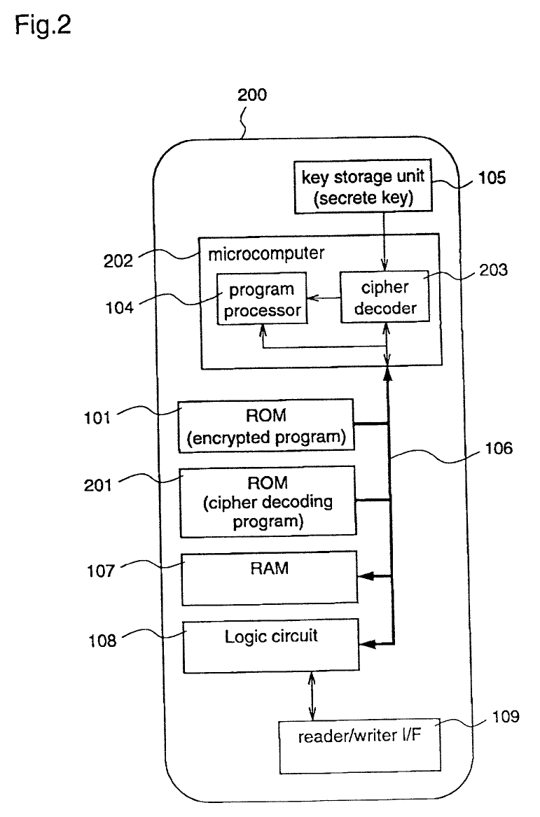

FIG. 2 is a block diagram illustrating a structure of an IC card according to the second embodiment of the present invention. The IC card 200 according to the second embodiment replaces the cipher decoder in the IC card according to the first embodiment with a cipher decoder 203 for carrying out decoding of an encrypted program in the ROM 101 on the basis of a cipher decoding program. In this figure, the same reference numerals as those in FIG. 1 denote the same or corresponding parts. In a ROM 201, the cipher decoding program is stored. The cipher decoder 203 in a microcomputer 202 executes the cipher decoding program stored in the ROM 201, thereby decoding the encrypted program in the ROM 101 using a secret key in the key storage unit 105.

Hereinafter, the operation of the so-constructed IC card according to the second embodiment will be described. When a command for executing a predetermined program is input to the Logic circuit 108 in the IC card 200 via the reader/writer I/F 109, the Logic circuit 108 notifies the microcomputer 202 that the command is input. Then, the microcomputer 202 receives this instruction and reads the cipher decoding program from the ROM 201. The readout cipher decoding program is transmitted to the cipher decoder 203 in the microcomputer 202 via the data bus 106. Then, the encrypted program is decoded by the cipher decoder 203 in which the cipher decoding program is executed, using the secret key readout from the key storage unit 105, and this decoded program is transmitted to the program processor 104 and executed by the program processor 104. As described above, the IC card 200 is operated by repeating the successive decoding of the encrypted programs by the cipher decoder 203 using the cipher decoding program and the execution of the decoded programs.

Also in this second embodiment, the encrypted program is decoded by the cipher decoder 203 in the microcomputer 202 using the software, whereby the same effects as those in the first embodiment are obtained.

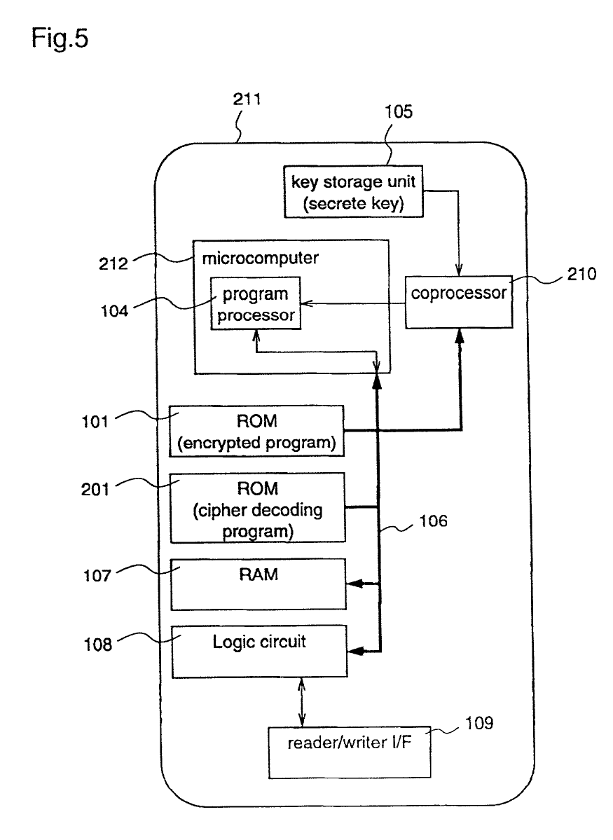

In this second embodiment, the decoding of the encrypted program is carried out by the cipher decoder 203 in the microcomputer 202. However in this invention, as shown in FIG. 5, an IC card 211 can have a structure where a coprocessor 210 is provided outside a microcomputer 202, in place of providing the cipher decoder in the microcomputer of the IC card according to the second embodiment, and the cipher decoding program in the ROM 201 is executed by the coprocessor 201, thereby decoding the encrypted program using the secret key from the key storage unit 105. In FIG. 5, the same reference numerals as those in figure 2 denote the same or corresponding parts. However, in this case, it is preferable to make it difficult to read the decoded program by performing the delivery of the decoded program from the coprocessor 210 to the program processor 104 in the microcomputer 202, for example, not via the data bus 106 but using a special signal line as shown in FIG. 5.

### Embodiment 3

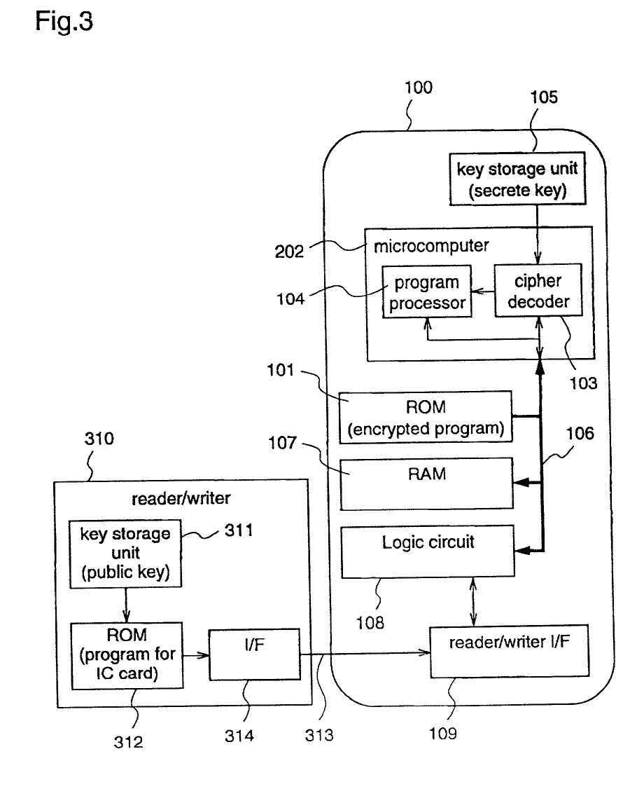

FIG. 3 is a block diagram illustrating a structure of an IC card utilization system according to the third embodiment of the present invention. This IC card utilization system utilizes the IC card shown in the first embodiment, and transmits an encrypted program from an IC card reader/writer 310 outside the IC card 100 to the IC card 100, decodes the encrypted program in the cipher decoder 103 in the IC card 100 and executes the decoded program in the program processor 104.

In FIG. 3, the same reference numerals as those in FIG. 1 denote the same or corresponding parts. A reader/writer 310 outside the IC card 100 encrypts a program which is stored in a ROM 312 and used by the IC card, using a public key 311 of the public key cryptosystem stored in a key storage unit 311 inside the reader/writer 310, and thereafter transmits the encrypted program 313 from an interface (hereinafter referred to as I/F) 314 to the IC card 100. In the IC card 100, after the transmitted encrypted program is input via the reader/writer I/F 109, the encrypted program is decoded by the cipher decoder 103 using the secret key read from the key storage unit 105 and the decoded program is executed by the program processor 104.

In this IC card utilization system according to the third embodiment, when the program stored in the TOM 312 of the reader/writer 310 is executed in the IC card 100, the program in the ROM 312 of the reader/writer 310 is encrypted using the public key in the key storage unit 311 and thereafter transmitted to the IC card 100. Then, in the IC card 100, the encrypted program is decoded using the secret key and executed. Therefore, even if the encrypted program 313 is leaked out between the reader/writer 310 and the IC card I/F 109 or monitored on the data bus 106, it is difficult to decode the encrypted program. Thereby, the IC card utilization system having an excellent security function can be provided.

In this third embodiment, the encrypted program transmitted from the reader/writer 310 is directly input to the cipher decoder 103 and decoded. However in the present invention, the encrypted program can be used after being temporarily stored in a memory such as the RAM 107 of the IC card 100. Also in this case, the same effects as those in the third embodiment can be obtained.

In addition, in this third embodiment, the program processor 104 of the IC card 100 can be executed by the program of the reader/writer 310. Therefore, the ROM 101 of the IC card 100 can be omitted as required.

Further, in the IC card utilization system according to the third embodiment, the secret key for decoding the encrypted program in the ROM 101 or the secret key used in the decoding of the encrypted program transmitted from the reader/writer 310, which is stored in the key storage unit 105 of the IC card 100 can be the same key as the secret key used for card authentication of the IC card 100. The normal card authentication is performed as follows. Predetermined authentication information is transmitted from an authentication information transmission/receiving unit (not shown) of the reader/writer to the IC card, then the IC card processes this information in the Logic circuit or the like using the secret key and thereafter returns the information to the reader/writer, and the authentication information transmission/receiving unit of the reader/writer confirms whether the returned data have been processed by the normal secret key or not. However, there are many cases where this is performed only at a time when the operation of the IC card is started. On the other hand, when the secret key used for the authentication is used also for the decoding of the encrypted program, even if the card authentication is performed illegally without using the secret key, since the secret key is unknown, the program cannot be decoded normally and the IC card 100 does not operate normally. Therefore, as compared to the case where a different secret key is used only for the card authentication, the authenticity in the judgement of the authorized card can be increased.

It is also possible that the secret key and the common key used in encrypting or decoding of the common key cryptosystem are stored in the key storage unit 105, and the decoding by the secret key and the decoding by the common key is performed in the cipher decoder 103 of the IC card 100. It is also possible that the common key of the common key cryptosystem which has been encrypted by the public key of the public key cryptosystem is transmitted from the reader/writer 310, then the reader/writer 310 encrypts the program in the ROM 312 using the common key and transmits the same, and in the IC card 100, only the common key transmitted from the reader/writer 310 is decoded by the cipher decoder 103 by the secret key of the public key cryptosystem stored in the key storage unit 105, and the encrypted program transmitted from the reader/writer 310 is decoded using the decoded common key of the common key cryptosystem. The processing time required for the decoding is normally shorter in the common key cryptosystem. Therefore, by doing so, the processing speed can be increased with maintaining the security property, and the loads to the microcomputer can be reduced.

What is claimed is:

1. An IC card comprising:
a microcomputer having a program processing means for executing a program;
a program storage means for containing the program executed by the program processing means, at least part of the program having been encrypted;
a key storage means for containing key information; and
a cipher decoding means for decoding the encrypted program from the program storage means using the key information from the key storage means while giving the program directly to the program processing means.

2. The IC card of claim 1 wherein
the cipher decoding means is provided in the microcomputer.

3. The IC card of claim 1 wherein
the program stored in the program storage means is encrypted using a public key of a public key cryptosystem, and
the key information stored in the key storage means is a secret key of the public key cryptosystem.

4. The IC card of claim 1 wherein
the program stored in the program storage means is encrypted using a common key of a common key cryptosystem, and
the key information stored in the key storage means is the common key of the common key cryptosystem.

5. The IC card of claim 1 wherein
the program storage means is one of a ROM, a nonvolatile memory other than a ROM, and a RAM.

6. An IC card utilization system comprising:
an IC card reader/writer having a program storage means for containing a program, a first key storage means for containing first key information and encrypting the program in the program storage means using the first key information, and a first interface means for outputting the encrypted program outside; and
an IC card having a second interface means for receiving the encrypted program output from the IC card reader/writer; a second key storage means for containing second key information; and a microcomputer comprising a cipher decoding means for decoding the encrypted program input from the IC card reader/writer via the second interface means using the key information from the second storage means, and a program processing means for executing the decoded program.

7. The IC card utilization system of claim 6 wherein
the first key information is a public key of a public key cryptosystem, and
the second key information is a secret key of the public key cryptosystem.

8. The IC card utilization system of claim 7 wherein
card authentication is performed by decoding with operating the encrypted program, using the secret key stored in the second key storage means.
